(19) United States
(12) Patent Application Publication
(10) Pub. No.: US 2008/0012243 A1
(43) Pub. Date: Jan. 17, 2008

(54) Drive axle hub gasket and a method of using the same

(76) Inventors: Jason Altwies, Portage, MI (US); Steven G. Slesinski, Kalamazoo, MI (US); Leo Wenstrup, Portage, MI (US)

Correspondence Address: MARSHALL & MELHORN, LLC, FOUR SEAGATE - EIGHTH FLOOR, TOLEDO, OH, 43604, US

(21) Appl. No.: 11/446,566

(22) Filed: Jun. 2, 2006

(51) Int. Cl. F16J 15/02

(52) U.S. Cl. 277/637

(57) ABSTRACT

A gasket for a drive axle of a vehicle has an inner periphery defining an aperture and an outer periphery having a first diameter portion and a second diameter portion. The second diameter portion is greater than the first diameter portion. The gasket also has an intermediate portion between the peripheries. The intermediate portion has a plurality of apertures defined therein.

### FIELD OF THE INVENTION

The present invention relates to a drive axle hub gasket and a method of using the same.

### BACKGROUND OF THE INVENTION

Rear wheel drive vehicles typically have a differential housing, two axle housings, two axles that pass through the axle housings, two wheel hubs, and wheel bearings to support the axle housings on the wheel hubs. Each axle housing is hollow and attached to the differential housing. The axle housings and differential housing are typically a single unitary housing. Tires mounted on rims are conventionally attached to the wheel hubs. A lubricant is contained within the wheel hub to lubricate the bearings.

It is not uncommon for an axle to be removed from the hub, for example, when the vehicle is towed. Whenever an axle is removed from the hub, the known prior art designs cause the lubricant to be lost. The lubricant must be replaced before the vehicle can be put back in operation. Replacement of the lubricant is often difficult to do efficiently and accurately resulting in high labor costs and significant lost operational time of the vehicle.

Another disadvantage of the known prior art is that the type of wheel end installed on the vehicle cannot be identified unless at least one axle shaft is removed.

Examples of prior art devices include U.S. Pat. No. 5,190,355 which teaches a seal ring carrier located between a cap and a hub. A seal member depends from the seal ring carrier. The seal member slidably engages a non-rotating seal journal. The seal ring carrier has a plurality of fastener apertures for receiving the fasteners that secure the cap to the hub. The seal ring carrier separates a bearing grease cavity from an axle lubricant cavity via an inwardly extending radial wall that forms a circular opening to accommodate the journal, the cavity and the drive axle shaft.

U.S. Pat. No. 5,560,619 describes a gasket that attaches to the outer face of a wheel hub to form a barrier for lubricant. More particularly, the gasket can hold lubricant in place while the axle is reattached to the wheel hub. The gasket can be made of any conventional gasketing material that is relatively thin. Holes are provided to accommodate the bolts of the wheel hub. The gasket includes a solid interior retaining portion below an inner opening. The inner opening has a larger diameter than the outer diameter of the drive shaft. The solid interior retaining portion is only said to be of a predetermined area to partially cover the inner cavity of the wheel hub when the gasket is mounted to the outer face of the wheel hub. An adhesive can be applied to one face of the gasket to help the gasket stick to and seal with the outer face of the wheel hub.

### SUMMARY OF THE INVENTION

The present invention is directed toward a drive axle hub gasket having an inner periphery, an outer periphery and an intermediate portion. The inner periphery defines an aperture. The outer periphery has a first diameter portion and a second diameter portion. The second diameter portion is greater than the first diameter portion. The intermediate portion is located between the peripheries and it has a plurality of apertures defined therein.

### BRIEF DESCRIPTION OF THE DRAWINGS

The advantages of the present invention will become readily apparent to those skilled in the art from the following detailed description when considered in the light of the accompanying drawings in which:

FIG. 1 is an exploded schematic, perspective view of one embodiment of an axle shaft, a wheel hub and a gasket of the present invention;

FIG. 2 is a schematic, front view of one embodiment of the present invention;

FIG. 3 is a schematic, side view of the invention depicted in FIG. 2 as seen along arrows A-A;

FIG. 4 is a schematic view of the present invention of FIG. 2 taken along lines B-B;

FIG. 5 is a schematic, perspective view of another embodiment of the present invention;

FIG. 6 is a schematic, front view of another embodiment of the present invention;

FIG. 7 is a schematic, front view of another embodiment of the present invention;

FIG. 8 is a schematic, front view of another embodiment of the present invention; and

FIG. 9 is a schematic, front view of another embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

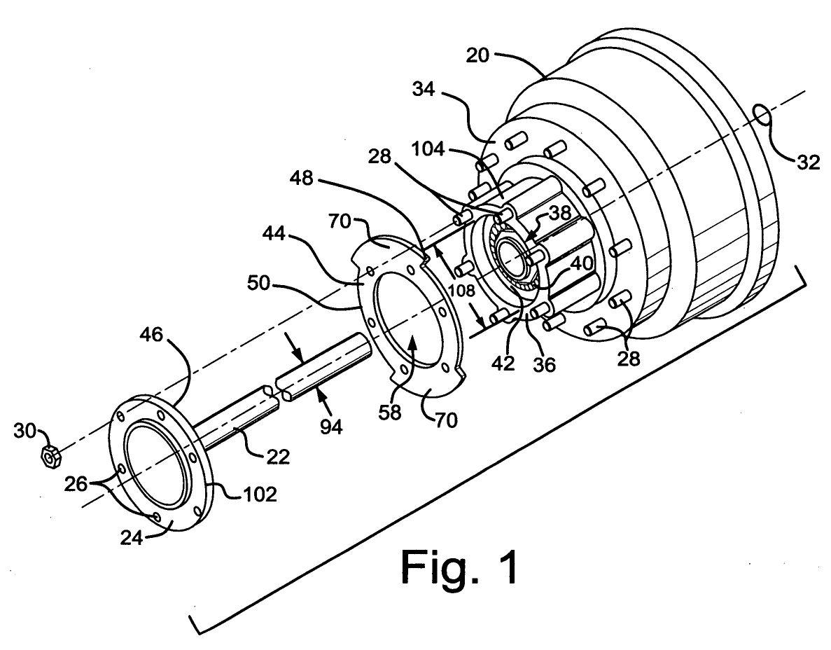

Referring now to FIG. 1, an exploded, schematic view of a wheel hub 20 and an axle shaft 22 for a vehicle (not shown) is depicted. The axle shaft 22 and wheel hub 20 may be part of a floating axle assembly. For the present description, a floating axle assembly is an axle shaft 22 that is removable from the wheel hub 20. Those skilled in the art appreciate that such an assembly typically includes a differential housing (not shown), an axle housing (not shown), the wheel hub 20, the axle shaft 22 and wheel bearings 40.

The axle shaft 22 is provided with a flange 24 containing a plurality of apertures 26. The apertures 26 receive threaded bolts 28 located on the wheel hub 20. The bolts 28 are located through the apertures 26 and a nut 30 is located on each bolt 28 to secure the axle shaft 22 to the wheel hub 20. FIG. 1 partially depicts one side of a floating axle assembly. It can be appreciated that a second substantially similar assembly is located on the other side of the differential housing.

The wheel hub 20 has an axis of rotation 32, an inner face 34, an outer face 36 and a cavity 38. A plurality of bearings 40 and a quantity of lubricant 42 are located within the cavity 38. The lubricant 42 reduces friction in the bearings 40 and transfers heat from the bearings 40.

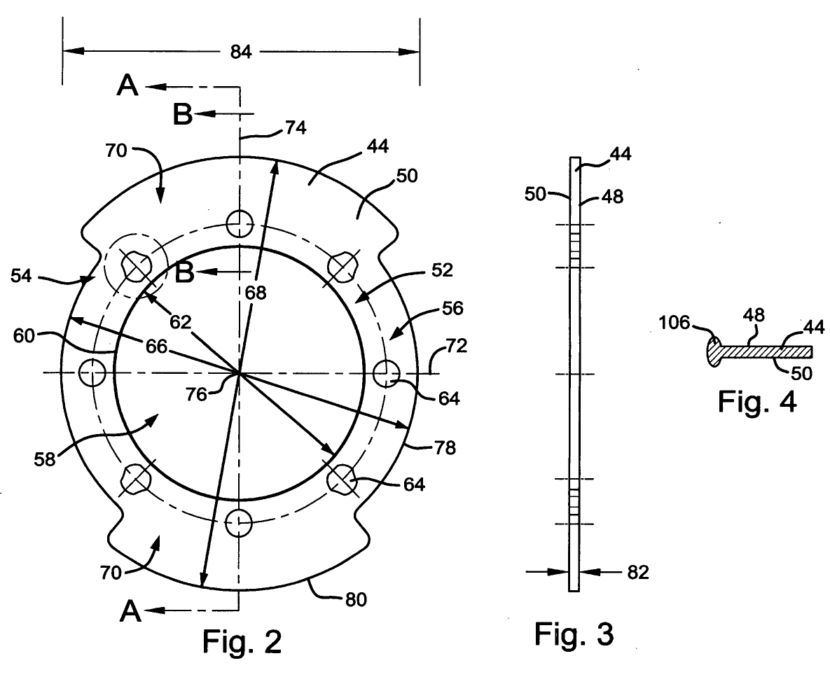

A gasket 44 is located between the outer face 36 and an inside surface 46 of the axle flange 24 to keep the lubricant 42 from leaking out between the hub 20 and the flange 24. Referring now to FIGS. 1-3, the gasket 44 preferably has a substantially planar inner face 48 and a substantially planer outer face 50. The gasket 44 also has an inner periphery 52, an outer periphery 54 and an intermediate portion 56. The inner periphery 52 defines an aperture 58 substantially centrally located in the gasket 44. This embodiment of the gasket 44 has an inner peripheral edge 60 with a substantially constant diameter 62. The intermediate portion 56 is located between the outer periphery 54 and the inner periphery 52 and it contains a plurality of apertures 64. The apertures 64 receive the bolts 28 from the hub 20.

The outer periphery 54 has a first diameter portion 66 and a second diameter portion 68. Preferably, the second diameter portion 68 is radially larger than the first diameter portion 66. It is also preferred that the second diameter portion 68 extend along the outer periphery 54 for a predetermined distance to create a tab 70.

As seen in the figures, the gasket 44 can comprise two second diameter portions 68 separated by first diameter portions 66. The second diameter portions 68 are preferably spaced equidistant from one another but they may be located any distance from one another. Further, while the gasket 44 is depicted as having two tabs 70, it can be appreciated that any number of tabs 70 may be located about the gasket 44 and they may be spaced any distance from one another.

When the two second diameter portions 68 are spaced equidistant from one another, the gasket 44 is substantially symmetrical about a horizontal x axis 72 and a vertical y axis 74. It can be appreciated that the plurality of apertures 64 in the intermediate portion 56 are preferably equally spaced from one another and located at substantially equal distances from a center point 76 of the aperture 58 thus making them symmetrical about the x axis 72 and y axis 74 also.

It can be appreciated that since first and second diameter portions 66, 68 are defined, that the outer edges 78, 80 of these portions 66, 68 are curvilinear. It is within the scope of the present invention, however, for the edges 78, 80 to be non-curvilinear.

Referring now to FIG. 3, it can be appreciated that the gasket 44 has a thickness dimension 82 that is much less than the width 84 of the gasket 44. FIG. 3 also depicts the substantially planar nature of the inner and outer faces 48, 50 of the gasket 44.

The gasket 44 may be constructed of a fiber composite material such as that available from Accurate Felt and Gasket Manufacturing Company, Inc. of Cicero, Ill. The fiber composite material is a micropore and hydrofused product currently having product number HFL971. Alternatively, the gasket 44 may be constructed of metal, such as steel, that has been overcoated with a rubber-like material. It is also within the scope of the present invention to form the gasket 44 of paper-like material, as known by those skilled in the art.

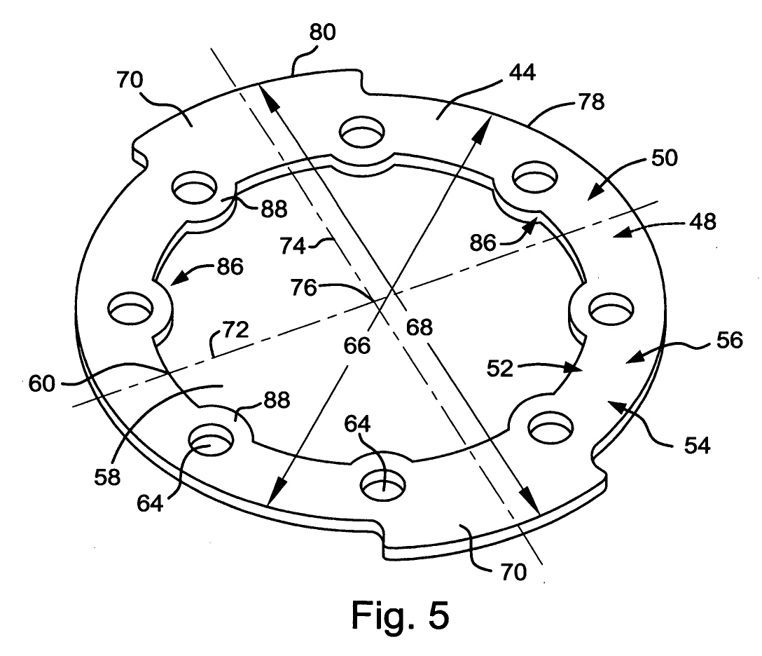

An alternative embodiment of the present invention is depicted in FIG. 5. The gasket 44 of FIG. 5 is substantially similar to the gasket 44 of FIGS. 1-3, thus the same reference numbers will be used for like features. The gasket 44 of FIG. 5, however, has an inner peripheral edge 86 that varies. More specifically, the inner peripheral edge 86 defines a circular portion 88 around each of the plurality of apertures 64. It can be appreciated that this embodiment of the gasket 44 utilizes less material that the gasket 44 of FIGS. 1-3. It should be appreciated that while the alternative embodiment of FIG. 5 is depicted with two tabs 70, as stated before, any number of tabs 70 is within the scope of the present invention and the tabs 70 may be located anywhere along the outer periphery 54.

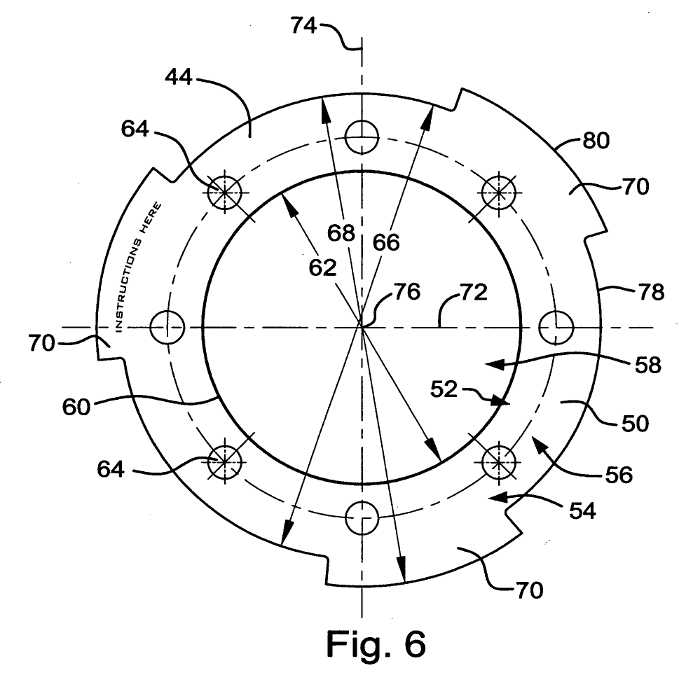

For example, FIG. 6 depicts another embodiment of the present invention that is substantially similar to the previously discussed and depicted embodiments, thus identical reference numbers are used again. In FIG. 6, however, three tabs 70, equally spaced about the outer periphery 54 of the gasket 44 are depicted. Again, it should be appreciated that it is within the scope of the present invention to locate the tabs 70 at any distance from one another.

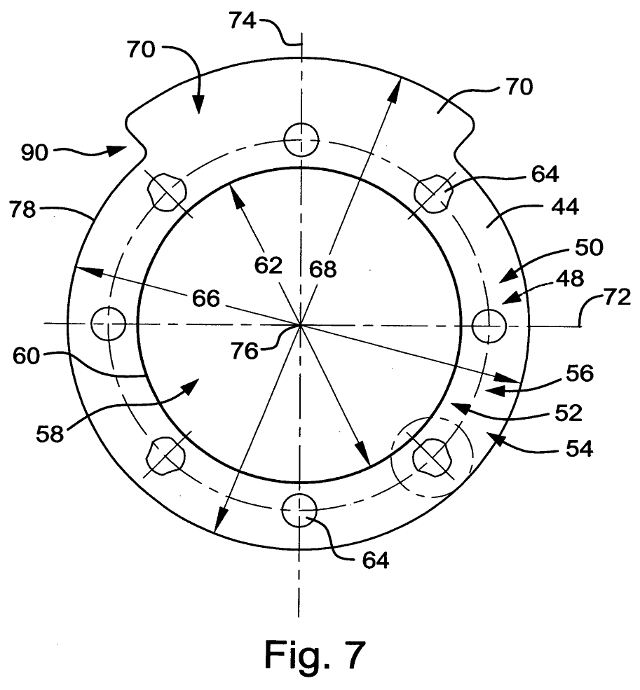

FIG. 7 depicts yet another embodiment of the present invention having just one tab 70. While the tab 70 is depicted as being located at an upper portion 90 of the gasket 44, the tab 70 can be located anywhere around the gasket 44. Furthermore, the tab 70 can comprise any portion of the outer periphery 54 of the gasket 44 and need not be limited to that which is depicted in the figure. The lightweight nature of the tab 70, or tabs 70 as depicted in the other embodiments, makes locating them anywhere about the outer periphery 54 possible as their impact on the balance of the wheel hub 20 and axle shaft 22 is negligible.

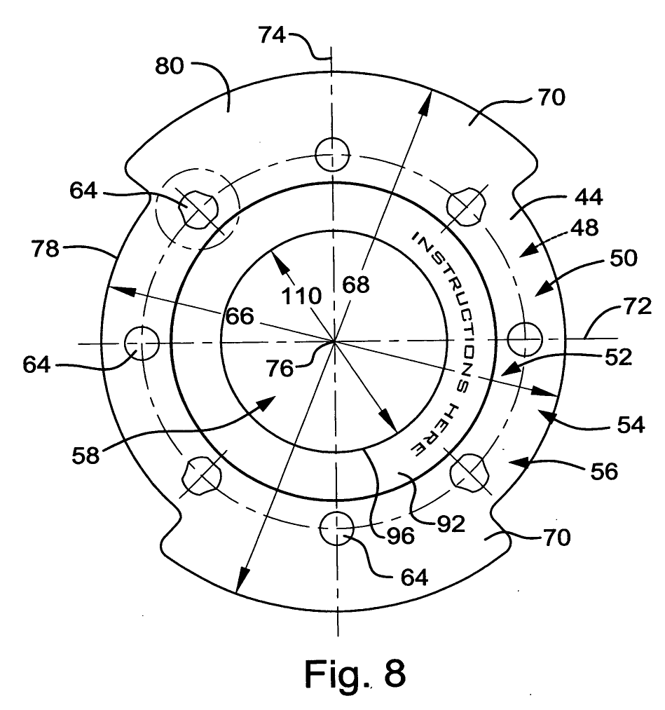

Another embodiment of the present invention is depicted in FIG. 8. While FIG. 8 depicts a gasket 44 with two tabs 70, it can be appreciated that any of the above discussed gaskets 44 can be used. The invention depicted in FIG. 8 differs from the inventions previously discussed in that it defines a dam 92. While the previously discussed gaskets 44 define wide apertures 58 for the axle shaft 22, the dam 92 comprises a portion of the inner periphery 52 that extends further inward toward the centerpoint 76 of the gasket 44. The dam 92 extends inwardly until it touches or almost touches an outer diameter 94 of the axle shaft 22. For clarity, the portion of the dam 92 that touches or almost touches the axle shaft 22 will be referred to as the inner dam edge 96. It can be appreciated that a smaller aperture 58 is defined by the gasket 44 of FIG. 8 for the axle shaft 22 than the apertures 58 of the preceding gaskets 44.

The dam 92 is preferably constructed of the same material as the gasket 44. In a most preferred embodiment, the dam 92 is one-piece and integrally formed with the gasket 44. It is within the scope of the present invention, however, to separately produce the dam 92 and to produce it from a material different from the rest of the gasket 44. A dam 92 produced in either of these ways can be attached to the gasket 44 by mechanical-type fasteners, couplings and/or adhesives.

In the embodiment depicted in FIG. 8, the dam 92 has a substantially constant inner dam edge 96 to contact or almost contact the entire circular outer diameter 94 of the axle shaft 22. The present invention, however, is not limited to dams 92 having only substantially constant diameters.

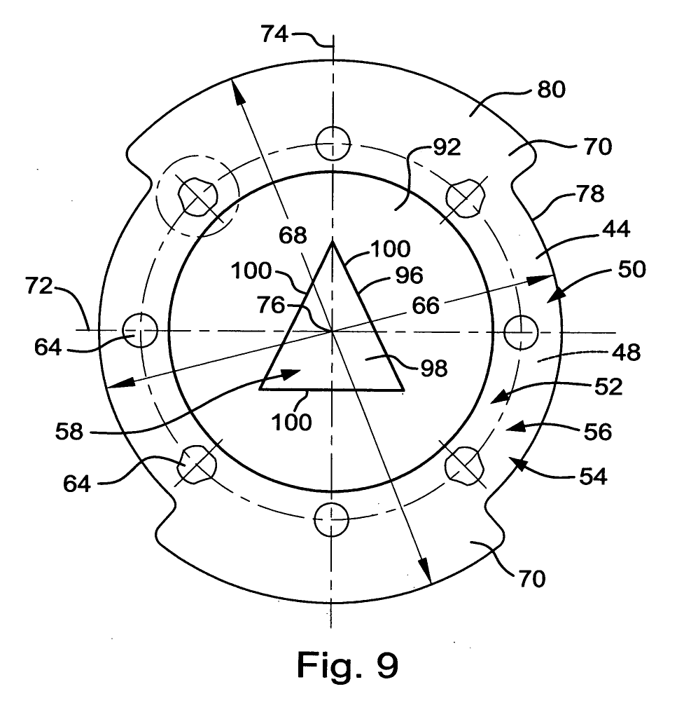

For example, as seen in FIG. 9, a dam 92 having a substantially triangular aperture 98 is depicted in the gasket 44. It can be appreciated that the substantially round axle shaft 22 fits through the triangular aperture 98. The axle shaft 22 may contact one or more of the sides 100 of triangle 98; openings at the apexes of the triangle 98 will likely exist.

While only circular and triangular dams 92 are depicted in the figures, it must be appreciated that the present invention is in no way limited to just these dams 92. Instead, dams 92 having any number of sides, shapes and dimensions may be used with the present invention.

Regardless of the dam 92 shape or style, it can be appreciated that the dams 92 provide additional surface area for the gasket 44. Much like the above discussed tabs 70, information regarding the gasket 44, the wheel hub 20 or any other component may be located on the dam 92 of the gasket 44.

A method of using the present invention comprises the following steps. It can be appreciated that the present invention has particular utility as a gasket between the outer face 36 and the flange 24 to prevent contaminants from entering the floating axle system or lubricant 42 from leaving the system.

The invention also has utility in that when the gasket 44 is installed on such a system, the tabs 70 extend outwardly from an outer edge 102 of the flange 24 and from an outer surface 104 of the hub 20. By extending beyond the flange 24 and the hub 20, information on the tab 70 or tabs 70 can be easily read by a service person working on any of the above-named components of the vehicle. For example, information regarding the wheel hub type can be located by any means on the tab 70. By locating the information the tab 70, one can view it without removing any parts to read it.

The axle shaft 22 can be removed from the wheel hub 20 and the gasket 44 preferably remains in place on the wheel hub 20. The gasket 44 can be assured to remain in place on the hub 20 when an adhesive is located on the inner face 48 of the gasket 44 so that it holds to the outer surface 104 of the wheel hub 20.

The adhesive may be any product known to those skilled in the art that will not interfere with the performance of the lubricant 42. One such product may be such as an RTV material, or a room-temperature vulcanizing material. Such materials are traditionally defined as rubber compounds that solidify and stabilize at room temperatures.

A similar or identical adhesive material 106 may be located, in addition to or separate from the adhesive on the face 48 of the gasket 44, about the inner peripheral edge 60 of the gasket 44, as seen in FIG. 4. In this location, the material 106 also secures the gasket 44 to the outer surface 104 of the hub 44.

When any of the above-described gaskets 44 have any one of the above-described dams 92, the dam 92 prevents or reduces lubricant 44 from escaping from the wheel hub 20 when the axle shaft 22 is removed. Those skilled in the art appreciate that an axle shaft 22 might be removed from the wheel hub 20 for many reasons including, but not limited to, when the vehicle is to be towed.

In a preferred embodiment, the inner dam edge 96 of the gasket 44 has a smaller dimension than a diameter 108 of the cavity 38 of the wheel hub 20. For example, if the gasket 44 having the dam 92 depicted in FIG. 8 is used, the inner dam edge 96 has a smaller diameter 110 than the diameter 108 of the cavity 38 of the wheel hub 20. It can be appreciated that the smaller diameter 110 of the inner dam edge 96 prevents lubricant 42 from spilling out of the wheel hub 20 when the axle shaft 22 is removed. Retaining this lubricant 42 within the wheel hub 20 is desirable since it is time consuming and expensive to replace and since it is difficult to replace accurately.

The dam 92 depicted in the gasket 44 of FIG. 8, or any other dam symmetric about a horizontal and a vertical axis 72, 74, permits the axle shaft 22 to be removed at any angular position of the wheel hub 20 or axle shaft 22. Thus, the wheel hub 20 or the axle shaft 22 need not be rotated to a particular angular orientation for the axle shaft 22 to be removed as the dam 92 will function equally well regardless of the angular orientation of the wheel hub 20, axle shaft 22 or the dam 92 itself.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A gasket, comprising:
an inner periphery defining an aperture;
an outer periphery having a first diameter portion and a second diameter portion greater than said first diameter portion; and
an intermediate portion between said peripheries, said intermediate portion having a plurality of apertures defined therein.

2. The gasket of claim 1, wherein said inner periphery has a substantially constant diameter.

3. The gasket of claim 1, wherein said inner periphery has a variable diameter.

4. The gasket of claim 1, wherein said second diameter portion extends for a predetermined length of said outer periphery to create an information tab.

5. The gasket of claim 1, wherein said outer periphery has two information tabs separated from one another by said first diameter portion.

6. The gasket of claim 1, further comprising a first substantially planar face and a second face substantially parallel to said first face, said faces integrally formed with, one piece with and forming said inner periphery, said outer periphery and said intermediate portion.

7. A gasketing and fluid damming device, comprising:
a gasket, comprising:
a curvilinear outer periphery having a first diameter portion of a predetermined length and a second diameter portion of a predetermined length, said first diameter portion being less than said second diameter portion to form at least one information tab; and
a lubricant dam located inwardly from said outer periphery; and
a hub containing lubricant therein, said hub mounting said gasket thereon to deter said lubricant from leaving said hub at any angular orientation of said gasket.

8. The device of claim 7, wherein said gasket is symmetrical about a horizontal axis and a vertical axis.

9. The device of claim 7, wherein an inside face of said gasket is in contact with said hub and a portion of said inside face of said gasket is in contact with said lubricant.

10. The device of claim 7, wherein said hub has a lubricant cavity with a diameter, said dam has an inner dam edge with a diameter and said axle shaft has an outer diameter, wherein said diameter of said inner dam edge is smaller than said diameter of said lubricant cavity but greater than said outer diameter of said axle shaft.

11. A wheel end system, comprising:
a gasket having an outer periphery and an inner periphery, said outer periphery having a first portion and a second portion, said second portion extending radially beyond said first portion to form at least one information tab, and a plurality of apertures being located between said outer periphery and said inner periphery;
an axle shaft and an axle shaft mounting flange secured to an end of said axle shaft, said flange extending radially therefrom to substantially cover said first portion of said gasket, said flange having a plurality of fastener apertures; and
a wheel hub having mounting bolts extending from a mounting face for extending through both said fastener apertures of said axle shaft mounting flange and said apertures of said gasket, said mounting face substantially covering said first portion of said gasket;
wherein information on said information tab is legible since said tab extends beyond said hub and said flange.

12. A method for retaining lubricant in a hub, comprising:
providing a hub containing a quantity of lubricant therein;
providing an axle shaft installed in said hub for rotation therewith and permitting an inner peripheral portion of a gasket to be located adjacent an outer diameter of said axle shaft; and
retaining said lubricant within said hub when said axle shaft is removed from said hub with a dam on said inner peripheral portion of said gasket, said gasket being located at any angular orientation when said axle shaft is removed.

13. The method of claim 12, wherein said inner peripheral portion of said gasket contacts said outer diameter of said axle shaft.

14. The method of claim 12, wherein said gasket retains lubricant in said hub when said gasket is located at any angular orientation because said gasket is symmetrical about a horizontal and a vertical axis.

15. The method of claim 12, wherein said gasket retains lubricant in said hub because said dam has a smaller inner diameter than a diameter of a lubricant cavity within said hub.
